(19) United States
(12) Patent Application Publication
(10) Pub. No.: US 2011/0254813 A1
(43) Pub. Date: Oct. 20, 2011

(54) POINTING DEVICE, GRAPHIC INTERFACE AND PROCESS IMPLEMENTING THE SAID DEVICE

(76) Inventor: Matteo Mode, Virgilio (IT)

(21) Appl. No.: 13/140,975

(22) PCT Filed: Jan. 13, 2010
(86) PCT No.: PCT/IT10/00005

§ 371 Date: Jun. 20, 2011

(30) Foreign Application Priority Data
Jan. 14, 2009 (IT) MN2009A000001

(51) Int. Cl. G06F 3/033

(52) U.S. Cl. 345/179

(57) ABSTRACT

A graphical interface pointing device comprising an optical assembly, image detection means, control and/or monitoring means, data transceiver means, feeding means and a central processing unit, a process for implementing said device, and a system implementing said method and device.

The present invention relates to pointing devices associated with electronic visualization and/or writing means.

A pointing device is a hardware component which allows spatial information associated with commands to be generated and communicated to a computer. In graphical interface systems (a system that makes commands available through the manipulation of visualized graphical objects) they can relate actual spatial information with that required to act within the virtual space or graphical environment produced on a screen. The virtual space is an active space, i.e. wherein an area or point is associated with abilities to activate one, zero or more functions. Pointing devices can provide spatial information as well as generate information for the activation thereof, generally by using buttons on the device and movements of the device or even a combination thereof.

Pointing devices are divided into two main categories, i.e. motion devices and positioning devices. Motion devices associate movements in the real space with movements in the virtual space or graphical environment regardless of the corresponding point of origin. On the contrary, positioning devices can uniquely associate a point of a discrete real space with a point of the virtual space. Therefore, in this case, there is an accurate match between the graphical environment and the discrete real space, and the movements are associated with a specific point of origin. When the dimensions of the real space match the size of a medium visualizing the graphical environment, such as a screen or projection plane, the match is one-to-one.

Positioning devices are divided either into devices recognizing the position of a pointer, which is generally a stylus or the like, in a real space which is different from the medium visualizing the graphical environment, such as for example capacitative surface media, infra-red grid media, magnetic field media, brightness field media, triangulation field media, field-of-view media of external video-cameras, or into devices which directly recognize the medium visualizing the graphical environment and/or the produced image of the graphical environment. Generally, these latter devices require special features of the medium or visualization system in order to identify one or more absolute references (special patterns, different degrees of brightness, LEDs, beacons) to which the determination of the absolute position can be related, thereby lacking in autonomy and great adaptability to the current commercially available and widely spread systems.

Pointing devices exclusively allow to “manipulate” the virtual environment produced by a graphical interface system and, therefore, the efficiency of use thereof is directly related to the degree of spatial interaction implemented by them. For example, a degree of manipulation implemented by a motion device is considerably lower than a positioning device, since it requires the user himself/herself to close the feedback loop by assessing the correct position of a cursor on the screen.

Therefore, the degree of interaction established between the user and a graphical interface system depends on the degree of spatial interaction implemented by the pointing device.

The invention seeks to address the problem of lack of autonomy in absolute pointing devices and the issue of increasing the degree of interaction made available by a single traditional pointing device between a user and a graphical interface system, between a user and more graphical interface systems, and between a user and a network of graphical interface systems.

Particularly, the invention aims to improve the portability of digital contents among independent graphical interface systems, to promote the digitalization of transferable physical contents (for example tickets, leaflets, banknotes, coins, flyers, paper notes, paper notifications, newspapers, magazines, books, etc.), and simultaneously to assure a high, if not improved, degree of security, privacy and copyright.

For example, to date, when information has to be transferred from the memory of a system to the memory of a similar system, one has to connect the two systems, read through the memory of each other, give a transfer command, and disconnect both the systems once the transfer has been completed, thereby engaging the user in a significant number of operations and setting-up an interaction between two systems which is affected by clear security and privacy risks. The question is if it is possible both to minimize the commitment demand for the user through a new generation of user/computer interaction devices, and simultaneously to assure a safe transfer.

Therefore, an object of the present invention is a graphical interface pointing/interaction device comprising an optical assembly, image detection means, control and/or monitoring means, data transceiver means, feeding means, and a central processing unit. Advantageously, the device can be provided with a pressure sensor near the optical assembly.

The device can be provided with data storage means.

Furthermore, the device can be provided with user authentication means both as a digital signature support means and as an authentication means, for example of a biometric type.

As for the mere pointing function, the device is particularly and primarily characterized at a hardware level by the specific features of the optical components and image acquisition components.

Another object of the present invention is a process to determine the absolute position, which process is carried out by a pointing device of the above-described type, comprising the steps of acquiring images; measuring the vector distance in the detected image between the position of the pointer of said device and the position of at least one static or dynamic feature whose position is known with respect to the screen and which is produced by the screen, said measurement being performed by counting the vertical and horizontal pixels (pixels of the sensor); converting said measurement based on the input-output function of the optical assembly and the degrees of proximity and inclination as calculated through the same image; and, finally, transitively determining references for the absolute position of the pointer of the device with respect to the screen.

In relation with such process and device there are developed appropriate processes for correcting an error as well as for resolving ambiguities in the positional output, which processes can be implemented if needed.

Another object of the present invention is a process for measuring the proximity, inclination and rotation of the device based on the measurement of deformations or effects introduced by such magnitudes into the detected image of static or dynamic features whose aspect ratios are known, such as primarily the pixel grid of the screen.

Furthermore, an object of the present invention is a process for uniquely recognizing a pixel-grid screen over other pixel-grid screens or surfaces, based on detecting and recognizing either static or dynamic features with a high discrimination power, such as particularly the pixel grid, or unique static or dynamic features as properly established and visualized if necessary.

Another object of the present invention is a system comprising a device of the above-described type, a software interface able to couple said device to one or more processors, and one or more visualization devices coupled to said processors.

Further advantages and features of the present invention will be apparent from a detailed description of an embodiment thereof, which is provided by way of example, and not by way of limitation, with reference to the accompanying drawings, wherein:

FIG. 1 is a schematic diagram showing the image acquisition system according to the present invention;

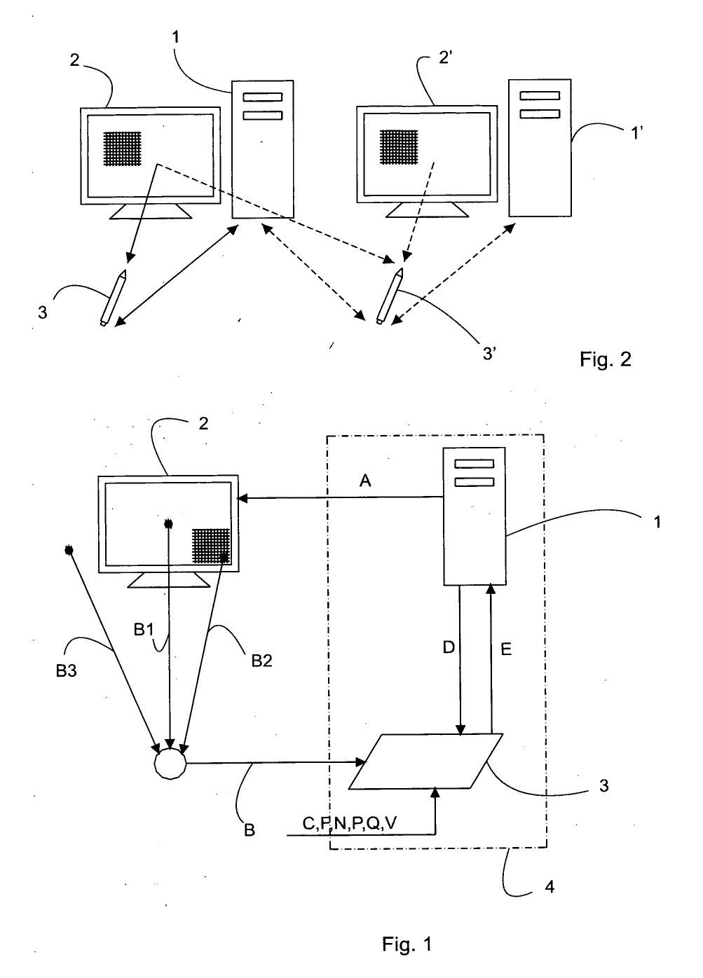

FIG. 2 shows potential interactions of the system according to the present invention by using more pointing devices and terminals;

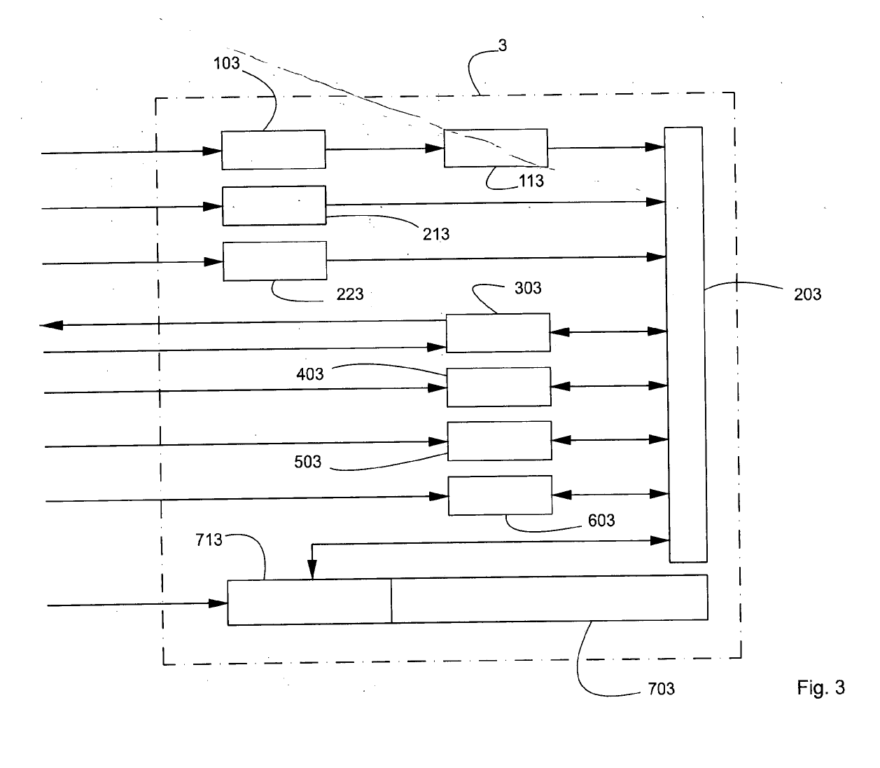

FIG. 3 is a block diagram showing an embodiment of the components of the pointing device according to the present invention;

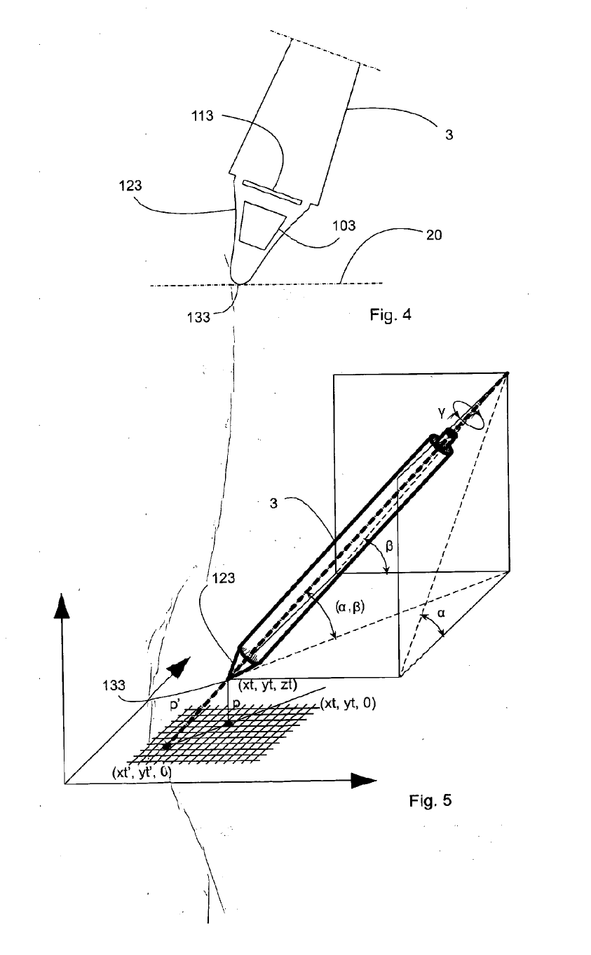

FIG. 4 is a schematic side-elevation view of a detail of the device according to the present invention;

FIG. 6 is a schematic perspective view showing how the pointing device according to the present invention operates; and

FIG. 6 is a schematic diagram showing an aspect of the image acquisition process according to the present invention.

FIG. 1 is a schematic diagram showing the image acquisition system according to the invention; reference numeral 1 denotes the computer of the system. Pixel-grid screen 2 is used by computer 1 to visualize the graphical environment. From the screen 2 there can be discriminated static elements, i.e. those producing an image which is consistent over time (for example, the borders and matrix of pixel rows), and dynamic elements, i.e. those producing an image varying over time (for example, the pixels).

The hardware device is denoted by reference numeral 3, while the piece of software 4 is an algorithm implementing the functionalities of the device 3 in the computer 1. Since such piece of software is an intangible component implemented by physical (hardware) media, it can be either not shared at all or partially shared between the physical device and the hardware components external therefrom (the computer). As a result, the structure of the internal processor of the hardware device will be influenced by the choice of distribution of computational loads. Therefore, the piece of software can be supported by the hardware device alone or by the computer alone, or by a combination thereof.

Signal A represents the encoding of the graphical environment in which the graphical interface is implemented to access the functions. Signal B represents the image which can be detected by the device. In signal B there can be distinguished three contributions provided by signals B1, B2, and B3.

Signal B1 represents the image as produced by the pixel matrix forming the screen. B1 is the visible image corresponding to A, and thereby it is characterized to be dynamic over time.

Signal B2 represents the image as produced by structural components of the screen such as, for example, the side frame and matrix of rows separating the pixels (“pixel grid”). This signal is stationary over time because it is associated with the hardware portion of the screen.

Signal B3 is the remaining component of B following the subtraction of both B1 and B2, and it represents the image of the external environment. Component B3 is naturally unpredictable.

Signal C represent the pressure applied by the user to the device through the interaction with a surface.

Signal F represents optional buttons or switches or rollers being activated by the user. Signals B, C e F comprise information useful for the invention to generate spatial information associated with commands in order to interact with the graphical interface. Signal N represents a memory card being inserted or removed. Such a signal exists only if a removable memory card is implemented by the device.

Signal P represents a digital signature card being inserted or removed. Such a signal exists only if a digital signature card is implemented by the device. Signal Q represents the transmission of authentication information associated with the user of the device, provided that such a process is contemplated. Signal V represents the transmission for the recharging system of an internal battery of the device.

Signals D and E are of an electric or electromagnetic type depending on the technology employed to communicate between the hardware device and the computer. Their information contents depend on how the distribution of processing tasks between the hardware device and the computer is designed.

FIG. 2 represents an example of the interaction capabilities of the invention with more graphical interface systems, each consisting of a computer and one or more pixel-grid screens. The invention allows the system 1 to exclusively interact with the device 3, a device 3′ to simultaneously interact with different systems 1 and 1′, and a system 1 to simultaneously support more devices 3 and 3′.

FIG. 3 illustrates an embodiment of the pointing device 3 by means of a block diagram. The device includes an optical assembly 103, an image sensor 113, a pressure sensor 213, one or more control means 223, a memory 403, a digital signature support structure 503, a user authentication support structure 603, a controller and/or processor 203, a transmitter/receiver 303, a battery-recharging system 713 and a battery 703.

Optical assembly 103 is an optical system providing an “omni-directional” view with a field of view designed to capture both the image of the structure of the pixel-grid screen and the image produced by the visualization surface of the pixel-grid screen (static and dynamic image) when the pointer is in contact with or close to it and according to the intended uses. Furthermore, optical assembly 103 produces an image of the surroundings of the pointer, which is adapted to be resolved by the sensor 113 by discriminating the rows separating the pixels of the screen (“pixel grid”). Considering the resolution of the sensor, the input-output behaviour of the optical assembly 103 has to allow this latter to produce outputs having the required degree of discretization.

Optical assembly 103 can be a fisheye system, a multi-image system, a catadioptric system, an internal reflection system, a mirror-combination system and the like, and since this optical assembly provides a “side” view, it generally outputs an image which is deformed with respect to that obtained from a “frontal” view (with a remote lens). The input-output transfer characteristic is known.

Optical assembly 103 is designed to provide the above-described view under any intended condition of use. The conditions of use can vary within certain restricted ranges in terms of:
1) proximity between the optical assembly and the surface of the screen;
2) inclination of the optical axis with respect to the surface of the screen;
3) Cartesian position of the optical assembly with respect to the surface of the screen.

For each range of variation there is a critical value on which the sizing of the input field of view can be based. Such critical value is the value in the range for which the size of the field to obtain the view of the restricted surface is highest.

A fourth variable has to be added to the three above-described variables defining the conditions of use:
4) rotation of the optical assembly about its own axis (optical axis or main axis).

Typically, the range of variation is a whole round angle. This variable doesn't have a critical value on which the field of view is sized, but it forces this latter to be symmetrical with respect to the optical axis.

As it will be better understood hereinafter, the field of view is required to be minimally sized to allow at least one feature of the screen, whose position is known, to be detected under any circumstance.

Finally, the optical assembly has to be designed verifying that it can detect the pixel grid of the screen in the area around the pointer of the hardware device under every intended condition of use.

Therefore, the sizing is performed taking in account the ranges and relevant critical points as previously described.

Image sensor 113 is an optoelectronic component which converts a visual image into an electric signal describing it according to a certain encoding. Examples thereof are CCD sensors, CMOS sensor, FOVEON sensors.

Generally, considering the input-output behaviour of the optical assembly, the (spatial-, intensity-, colour-) resolution of the sensor has to be such as to allow the image of the used static and dynamic features to be detected under any intended condition of use, with a sampling level dependent on the algorithms being used. The resolution level depends also from the degree of accuracy to be obtained for the outputs produced by the processing tasks.

Generally, the frame rate of the image sensor 113 is sized to the maximum value selected from the value required to allow the invention to produce outputs appearing as instantaneous for the (human) user during the intended use; the value required to allow movements of the device to be sufficiently sampled over time during the intended use; and the value required to allow possible operational information transmitted through the screen to be detected (for this last value one has to consider, at most, the maximum refresh rate of commercially available screens—at most because operational information transmitted through the screen could also be visualized for more than one frame).

Clearly, when the optical core is sized (optical assembly 103 and sensor 113), the requirement for obtaining a wide adaptability of the invention to existing screens forces both the range of variation in which the size of the pixel grid of commercially available screens is and the range of variation in which the size of these latter is to be construed as a reference.

Pressure sensor 213 converts a mechanical stress into a coded electric change. However, the pressure input of the device 3 can be optically detected, for example by detecting the movements of a mechanical component as induced by such pressure with respect to a reference.

Control means 223 comprises a button or switch or roller or whatever switching device. There can be more than one switching devices. Information generated by means of a switching device can be intended to activate functions of the computer or device (for example: switch on/off).

Controller and/or processor 203 are an electronic component intended to monitor the device and the processing of data. The features of processor 203 depend on the computational load required both to process detected data and to manage and monitor the internal components and relationships with external systems.

Reference numeral 303 denotes an electronic component to physically interface the transmissions with the computer. Preferably, it is a wireless system.

An optionally removable non-volatile memory 403 is intended to store information contents large in size. Memory 403 is not to be confounded with the non-volatile memory optionally existing in controller 203. Preferably, memory 403 is a flash-type memory because of its robustness, impact and stress strength, reduced size, and ability to store data without power.

Reference numeral 503 denotes the structure required to enable the digital signature process, for example when a smart card is required to be used. The existence of a digital signature process doesn't depend on component 503. For example, it can be performed by using a “virtual smart card”, i.e. a smart card-like object stored as a file.

Reference numeral 603 denotes the structure optionally required to receive inputs for the user-authentication process. If the authentication occurs through the optical detection of biometric features, for example, then component 603 can be overlapped with optical assembly 103 and image sensor 113.

Battery 703 powers all the internal components of device 3.

The device according to the invention cyclically detects the image produced by the optical assembly thereof through the sensor, as required.

From the point of view of a user, hardware device 3 is geometrically characterized by the existence of a portion converging toward a point, referred as to a pointer, such as for example a rounded frusto-conical portion. As can be observed from FIG. 4, the device is designed as a stylus 3 provided with a frusto-conical end 123 in which the optical assembly 103 is accommodated; the frusto-conical end 123 has a rounded tip 133 intended to be contacted with the surface 20 of the screen, and the image sensor 113 is accommodated near the base.

The material and configuration of the pointer are designed both to minimize the wear thereof and of the screen, and to improve the sliding property during contact interactions. The distinctive use of the invention includes an interaction between the hardware device and the visualization surface of the screen. The hardware device interacts with the screen when the pointer of the device is faced toward the screen and in contact with or close to it. The user grasps the hardware device and, by using optional buttons and either mechanically contacting the pointer with the surface of the screen or moving the device, or a combination thereof, he/she interacts with the image produced by the screen.

The contact pressure can be more or less great, it can be either continuous or discontinuous over time, and it can be associated either with the use of optional buttons or with certain movements. The movements which can be applied to the device by the user during the interaction step between the device and the screen are as follows: moving the pointer toward or away from the plane of the screen, translating the pointer with respect to the plane of the screen, rotating the pointer about the main axis, and rotating the main axis with respect to the pointer, also referred to as tilting the main axis with respect to the plane of the screen. The variability in terms of both limits of variation and rate of variation for these movements is defined within a range which is related to human nature and technological constraints.

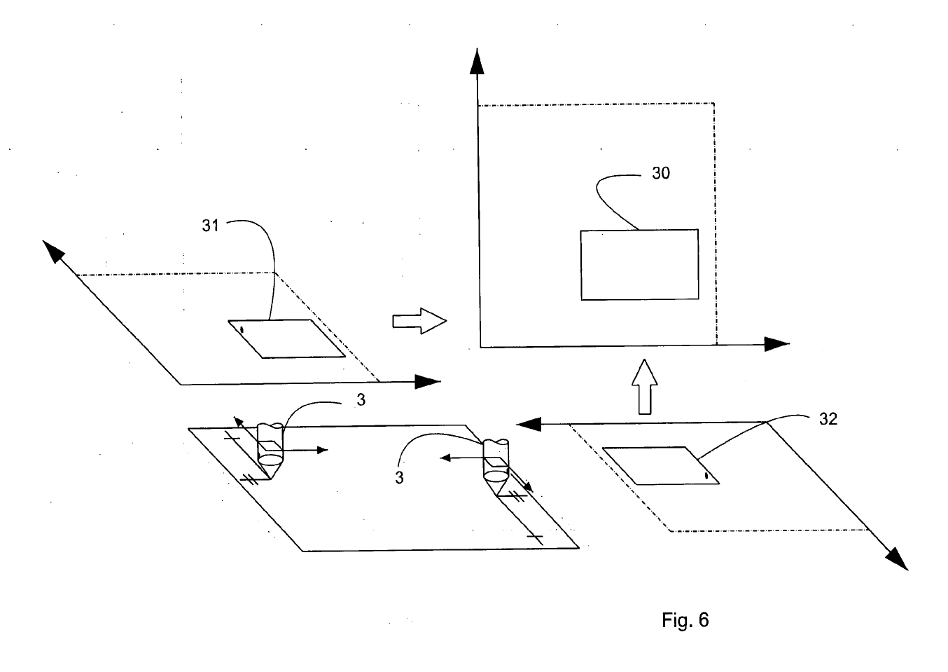

In FIG. 5 there is shown the device of the invention; like reference numerals refer to like parts. The position of the end 133 of the device 3 with respect to the screen is expressed by coordinates (xt,yt,zt), the translation of the pointer with respect to the plane of the screen is represented by a coordinate change (xt,yt), the proximity is represented by a variable (p) equal to (zt), the rotation of the device about its own axis is represented by an angle gamma (γ), and the inclination of the main axis of the device with respect to the plane of the screen is represented by a pair of angles alpha (α) and beta (β).

The value of (p) is derived from both the values of (p′) and the inclination angle defined by the pair (α) and (β) by trigonometric formulas applied to the right triangle.

The point with coordinates (xt′,yt′,zt′=0) represents the point at which the view of the optical assembly of the device is centred (intersection point of the main axis of the device with the plane of the screen). Coordinates (xt,yt) are derived from (xt′,yt′), (α), (β) and (p) or (p′) by trigonometric formulas.

Points (xt′,yt′, 0) and (xt,yt,zt) are coincident when the pointer is contacting the screen (minimal proximity).

The values for (xt,yt), the rotation about the optical axis (γ), the inclination centred at (xt,yt,zt) with respect to the screen (αand β) and the proximity (p) are independent from each other.

The value for (xt′,yt′), the rotation about the optical axis (γ), the inclination centred at (xt′,yt′,0) with respect to the screen (αand β) and the proximity (p′) are also independent from each other.

Under conditions in which the pointer is close to the screen and not in contact with the same and a position on the plane of the screen is to be determined, this position could be (xt,yt,0) or (xt′,yt′,0) as well as any other value (x,y,0), because it is not possible to determine a priori, for example, which path will be travelled by the pointer to come in contact with the screen and, above all, which point of the screen will be finally contacted by the pointer. If the coordinates of the pointer are (xt,y(zt>0), then it is possible to arbitrarily set a value (x,y,0) on the plane of the screen which could be reasonably included within the surroundings of the point (xt,yt,0) in any case.

The resulting digital image is analyzed in order to determine whether the pointer of the device is close to or in contact with the visualization surface of a pixel-grid screen.

We discriminate two components forming the overall image of the pixel-grid screen: the static component produced by passive elements forming the pixel-grid screen (for example: the pixel grid and the borders), and the dynamic component produced by active elements, which dynamic component corresponds to the effective image of the virtual graphical environment.

The analysis is based on searching for characteristic elements of the screen within the image which are known a priori. Those elements producing an image which can be discriminated from the image of the spatial or temporal contour thereof are “characteristic elements” or “features”. A composition of more features is a feature.

Characteristic elements or features are known if it is possible to determine a corresponding description thereof before or while the corresponding image is being detected.

For example, the border, pixel grid and brightness of the screen are “known static features”, while the graphical objects contained in the graphical environment being visualized are “known dynamic features”.

A feature can be known because it is generally established (for example: the pixel grid is formed by perpendicular straight lines), because it has been previously detected (for example: the borders of the screen as measured during an initialization step), because it is obtained from an information exchange with the system generating it (for example: the frame of the graphical environment), because it is related to other catalogued information (for example: the border is sized in a certain manner because the screen is of a given brand and model), or because it is generated according to the invention (for example: an appropriate cursor as visualized on the screen).

The features selected for the recognition activity are searched for within the detected image according to the shape they would have therein as a result of the input-output behaviour of the optical assembly under the intended conditions of use.

“Omni-directional” optical systems produce an image which is the result of countless contiguous “side views” for each of the countless directions contained in the field of view. If the object is always the same, the image produced by these systems is then extremely different from the image which would be produced by a front view mono-directional system.

As already mentioned, the conditions of use vary according to the degree of proximity between the optical assembly and the surface, the inclination of the optical axis with respect to the surface, the rotation of the optical assembly about its own axis, and the Cartesian position of the optical assembly with respect to references of the surface.

Generally, the optical systems (having a symmetrical behaviour with respect to their own axis) produce different images as the above-mentioned values are changed: the degree of proximity determines the enlargement ratio; the inclination of the optical axis with respect to the surface (object) determines an enlargement ratio varying while moving along the surface, since the portions of such surface are not equally spaced from the optical assembly; the rotation of the optical assembly (and then the rotation of the sensor coupled thereto) about its own axis determines the orientation of the digital image produced by the sensor; the Cartesian position of the optical assembly with respect to the surface determines the position of the objects within the detected image.

Therefore, the variability of the conditions of use determines a high number of potential detected images as expected when the object input of the device is the same. In order to identify the features searched for within the detected image, information about geometric nature or aspect ratios is therefore very useful.

The detected image can be both optically and computationally transformed into the image which would be obtained with a different optical system and/or different values for the conditions of use, and the recognition activity can be performed on this image. A suitable transformation can make easy the recognition activity but its implementation by means of an optical system can be difficult or impossible, while its computerized implementation can be time-consuming and burdensome.

Clearly, skipping an image-transformation process means obtaining a significant saving of resources or improved performance in terms of both construction and operation.

The choice of the known features to be searched for within the detected image in order to recognize a pixel-grid screen is based on the following criteria: existence of the features, detectability of the features, degree of discrimination or uniqueness of the features, and features easy to be used.

The existence of the features is assured for static features since they are related to structural elements, and therefore they cannot be deleted. On the contrary, the existence of dynamic features is not assured because they could not exist within the graphical environments being visualized. For example, consider the cases of graphical environments which are homogeneous or consisting of the repetition of an identical basic unit (modular geometries). In these cases, appropriate dynamic features to be visualized, which are therefore known, can be created provided that they are detectable, distinctive and easy to be used.

The detectability of a feature depends on the abilities of the optical assembly, the sensor and the pixel-grid screen also with respect to the intended conditions of use.

As for the optical assembly and the sensor, it is required to consider both the spatial resolution power and the intensity resolution power. Particularly as for the optical assembly, it can be observed that an increased side resolution power is required to discriminate two contiguous points belonging to a plane from a side view in comparison with a front view, since parallel beams as detected in the former case appear to be less spaced from each other than in the latter case, where they are perpendicular to the projection plane. Therefore, the image of features greatly spaced from the optical assembly could be less detectable than that of shortly spaced features.

Screens are characterized by a given projection angle which depends, as for the pixel-grid screens, on the projection angle of basic units producing an image of the graphical environment, i.e. the pixels. Typically, the pixels of a screen have a projection angle which is smaller than a planar angle and, therefore, a side view close to or in contact with the visualization surface (as that provided) cannot optimally detect the image produced by greatly spaced pixels.

Accordingly, the detectability of features which are greatly spaced from the optical assembly could be compromised, resulting in a subsequent complication while choosing features to be searched for within the detected image. In fact, since the position of the device with respect to the screen is not known a priori (indeed, this is an aim/result of the invention), it is not possible to determine which features are close and then potentially detectable.

The problem can be resolved by identifying features, if any, for each area of the screen. However, if the existence of dynamic features was uncertain with respect to the whole screen, then they are most likely to not exist locally.

The static features, with particular reference to borders and pixel grid, since they are related to passive structural elements, have fixed specificities such as their position with respect to the screen and the differential brightness with respect to active elements, and therefore they can be used to size both an optical assembly and a sensor which can detect them under any intended condition of use. Using the pixel grid as a known static feature to be searched for within the detected image is highly advantageous because it can potentially be locally detected in any case, since it is evenly distributed over the whole surface of the screen.

The difference in brightness between static features and dynamic features allows the former to be detected even when the colour of the dynamic image is the same. Therefore, the resolution of the sensor in intensity and colour has to be such as to allow this difference to be detected.

Another aspect to be considered for easily detecting and recognizing the border of a screen is that it is often elevated with respect to the projection surface.

The degree of discrimination or uniqueness of a feature denotes the occurrence frequency of said element in the various scenarios where the invention could be asked to operate. The lower the frequency, the higher the degree of discrimination. The degree of discrimination is critical to carry out proper recognitions, for example, in order to not confuse a pixel-grid screen with either another surface or another pixel-grid screen.

Since static features are associated with structural elements, they have a high discrimination power with respect to surfaces other than a pixel-grid screen but a low discrimination power with respect to other pixel-grid screens. Indeed, for example, the image of a bright surface enclosed by a far less bright border and also characterized by a far less bright grid which is small in size and, especially, strictly defined under a geometrical point of view (for example repeated modules, perpendicularity, squares, etc.) can be related to a pixel-grid screen with a high degree of certainty. However, the same image with the same features doesn't allow two pixel-grid screens to be discriminated, especially if they are structurally identical.

Static features are useful to discriminate structurally different screens when the features of the screen to be recognized are known or when the features of other potential screens are known, which other potential screens are known to exist by the invention while being different from the screen to be recognized.

Dynamic features, especially if in a great number, have an high discrimination power with respect to surfaces other than a screen. In order to discriminate two even structurally different screens by using dynamic features, it is required to consider a great number thereof because of the high standardization of currently used graphical environments. Unique dynamic features can be identified to differentiate two pixel-grid screens when both the systems comprising them can be interacted (subjected to an information exchange).

Clearly, the higher the descriptive detail of the features, the higher their degree of discrimination. For example, searching for the image of a pixel grid consisting of identical repetition modules sized within a certain range is considerably different from searching for the image of a pixel grid consisting of identical repetition modules of a well-defined size.

The easy of use is a measurement of the efficiency of use of features which takes on account variables such as, for example, computational load, information exchange requirement, optical detectability, distortion affection recognisability, etc.

Dynamic features can naturally occur at different positions or have different shapes or quickly change and, for these reasons, they require a continuous and consistent information exchange with the systems producing them as well as a significant processing load, even only to select which features are to be considered in order to carry out the research within the detected image. However, also due to their nature, they can be governed and properly produced, if necessary.

As a result of opposite specificities, static features occur in a monotonous manner and therefore they can be used with a low resource consumption. For this same reason, static features can be used to differentiate two structurally different screens (different mesh of the pixel grid, size of the screen, brightness, etc.) by storing them in conjunction with the identification of the corresponding system (system name or address or code) during an initialization step. Other opportunities to obtain information about the structure of the screen are: directly receiving them from the system using the screen, or obtaining the model ID of the screen from the system, which can then use it to query a given database.

When the easy of use is being assessed, one has to consider the intended conditions of use for the device which contribute, as known, to produce different images or differently deformed images as the conditions are changed, provided that the input object is the same. Therefore, if the object is also changed (this is the case of dynamic features), then the resource consumption for the recognition process is surely increased.

Therefore, as for the static features, setting up a recognition process for the static features, even when they are affected by distortions, is less labour-intensive.

Using features in the recognition process which are also useful to subsequent processes improves the operation efficiency.

Using dynamic features doesn't prevent from using static features and vice versa.

The general observation applies that the more the features searched for and the higher the degree of discrimination thereof, the higher the likelihood of performing proper recognitions. However, an excessively high number of features lead to a useless consumption of computational resources notwithstanding the resulting incremental advantage.

As a conclusion it can be generally stated that, in contrast to dynamic features, static features continuously exist, they can be potentially detected in any case while providing a high discrimination power (particularly the pixel grid), especially with respect to surfaces other than pixel-grid screens, and they are easy to be used. Dynamic features provide advantages such as governability and an increased discrimination power among pixel-grid screens, with the proviso that they exist and can be detected.

When the device is properly used and under frequently-encountered environmental scenarios, identification of features having a high discrimination power is sufficient to obtain a unique recognition of the screen of operational interest for the user.

Since there is no absolute assurance that a pixel-grid screen is uniquely recognized, there is introduced a specific process which will be explained hereinafter for sake of increased clarity.

Once the recognition process is concluded, if it is successful, then a process intended to determine the absolute position of the device with respect to the pixel-grid screen can be initialized.

The position of the pointer of the device with respect to the screen is transitively determined from references.

The position of the pointer with respect to the sensor, and then with respect to the digital image produced thereby, is known (by design). The position of the pointer with respect to given known features within the detected image is obtained by determining the position of such features. When the position of said known features with respect to the screen is known, the position of the pointer is determined with respect to the screen. The position of the known (static or dynamic) features with respect to the screen is known since they are produced thereby. Therefore, determining the position includes computing the vector distance between the pointer and at least one known feature within the image detected by the sensor.

Such measurement is made by counting the number of horizontal and vertical pixels (of the sensor) in the detected image as required to relate each considered feature to the point associated with the pointer.

When the input-output behaviour of the optical assembly is known, the resulting measurement is translated into the effective vector distance between the pointer and the feature.

When more features are considered, the ultimate result is the product of a mediation. The higher the number of features, the higher the quality of the resulting output. However, an excessively high number of features lead to a useless consumption of computational resources notwithstanding the resulting incremental advantage.

When the distance between two points within the image produced by the optical assembly is identical, the distance in pixels depends on the resolution of the sensor.

The distance between two points within the image outputted by the optical assembly depends on the distance of both the points corresponding to the input object from the optical assembly. Therefore, the input-output behaviour of the optical assembly and the conditions of use determine the position of the image of the effective objects within the detected image.

Indeed, for example, when the Cartesian position on the plane of the screen is identical, different degrees of proximity generally correspond to different enlargements, and different degrees of inclination correspond to different deformations, so that the measurement in pixels (of the sensor) is different from the same effective distance.

In order to weight the measurement in pixels of the sensor and obtain the effective distance, it is therefore required to detect the degrees of proximity and inclination to assess the input-output behaviour of the optical assembly.

The measurements of proximity and inclination are made based on the effects produced on features whose aspect ratios and mutual positions are known.

To this end, using the pixel grid which is evenly distributed over the whole visualization surface of the screen (known position) according to a strictly-defined geometry (modularity, perpendicularity, etc.) in any direction, so as to allow the effects introduced into the detected image from the degrees of proximity and inclination to be highlighted for each of them, appears to be extremely effective.

De facto, the pixel grid consistently describes the course for the area of the plane of the screen. Accordingly, analyzing how such area is deformed in the detected image allows the desired measurements to be obtained in an extremely fast manner.

Using the pixel grid of the screen allows the proximity to be expressed in relative terms, i.e. as a ratio of pixels of the screen to pixels of the sensor describing it in the detected image. Accordingly, the output for the absolute position of the pointer of the device with respect to the screen can be directly expressed in a measurement unit “number of pixels of the screen”.

Furthermore, it can be observed that using the pixel grid to obtain proximity and inclination allows the process for determining the absolute position to be related to the measurement of the distance even based on only one known feature, such as for example one corner of the screen.

The non-relative measurement of the proximity is critical in order to determine the distance from the screen, and then the absolute position of the pointer, not only in two dimensions but in three ((xt,yt,zt>0)—see FIG. 5) as well as to obtain the contacting status between the pointer and the screen (minimal proximity), especially when pressure sensor is not present.

Because of the perpendicularity of the straight lines describing the pixel grid, the pixel grid allows also the rotation of the optical assembly about its own axis, as well as of the sensor coupled thereto, to be effectively assessed.

Because of the symmetrical geometry of the pixel grid, the rotation computable only through the use thereof cannot be referred to an accurate mutual orientation of both reference axes of the grid and reference axes of the sensor and, in the case of a square grid, it can range from 0 to 45 degrees.

However, in the case of a rectangular screen, determining the so-obtained rotation is sufficient to indicate the direction in which the borders are to be searched for within the detected image, which borders are indeed known to exist at the whole perimeter of the pixel grid and to be generally perpendicular to the straight lines forming them (once the directions are determined, the borders are searched for in both the senses of each direction).

The rotation in absolute terms can be determined if the orientation of the fixed references of the screen can be defined. This can be done if it is possible to detect a feature having a unique known orientation with respect to the references of the screen.

Particularly in order to recognize the fixed references of the screen, using the image of the sub-pixel grid appears to be highly convenient. In fact, the sub-pixel sequences comprise combinations having an orientation with respect to the screen which is distinguishable and known.

Using this information, it is possible to define an origin for the measurement of rotation if it is made based on the pixel grid or otherwise based on other features which are not sufficient to determine an orientation.

For example, uniquely oriented combinations can also exist because the sub-pixels have an apparently oriented shape (e.g. a triangle shape), or the sub-pixels are arranged according to apparently oriented geometrical shapes (e.g. triangles), or the sub-pixels are arranged in such a way to form shapes with colour sequences defining an apparent orientation thereof.

The measurement of the rotation in absolute terms or otherwise the recognition of fixed references of the screen is extremely useful, as will be better explained hereinafter, to prevent potential ambiguities of the positional output from being generated.

However, a single sub-pixel can also be not detectable if it is switched-off. A single switched-off sub-pixel doesn't compromise the ability of identifying an oriented sequence. Obviously, when more contiguous sub-pixels are switched-off, the process as proposed could be not feasible.

It is underlined that the sub-pixel matrix is a pixel matrix, and therefore it is subjected to the same behaviours and criteria as associated with a pixel matrix.

Measuring the change of proximity, inclination and rotation over time (time-course analysis of successive frames captured by the sensor) is critical in determining the movements of the pointer within the three-dimensional space close to the screen, and possibly in associating commands therewith.

With reference to FIG. 5, given the design constrains dictating the ability of the optical assembly in detecting the image of the pixel grid in the surroundings of the pointer, and given the symmetrical behaviour of the optical assembly, it is preferred to refer the measurements to the image of the point in which the field of view of the optical system is centred, i.e. the point (xt′,yt′,0). Therefore, the point of the detected image which is associated with the pointer is the image of the point (xt′,yt′,0) as defined by the optical axis intersecting the sensor. From the determination of (p′), (α) and (β) can be easily derived, both (xt,yt,zt=p) and (xt,yt,0).

When the borders of the screen are used as a known reference feature, there are some benefits in addition to the fact that a border is a static feature. It allows the position to be expressed with respect to perimeter features thereby avoiding a transition between references, it exists in every direction of view, and it eliminates the requirement of knowing the effective size of the screen since it is possible to work with aspect ratios.

Locally, the distance between a feature and the pointer can be measured regardless of the proximity or inclination condition of the device, by discriminating the pixel grid of the screen and counting the numbers of horizontal and vertical pixels (pixels of the screen) required to relate the feature of the corresponding point to the position of the pointer in the detected image.

The provision of locality prevent the pixel grid of the screen from being undetectable due to both the resolution power of the optical assembly and the projection angle of the screen as associated at “large” distances.

The so-obtained measurement is independent from proximity and inclination because the different degrees of enlargement and the introduced deformations change the presentation of the pixel grid of the screen without compromising the uniqueness of the individual pixels forming the same in the detected image.

The degree of accuracy of this second measurement technique is increased, but the constrain of locality required for its implementation prevents a general use thereof since there is no assurance a priori that any recognizable static or dynamic feature is close thereto.

While selecting the features to be used in the position-determination process, the already-discussed considerations apply as for the recognition process, except that those relating to the degree of discrimination. However, using features having a high degree of discrimination inherently allows the position-determination process also to carry out a recognition process.

It is worth to underline that, in the case of static features, their position with respect to the screen doesn't change while, in the case of dynamic features, their position changes along with them each time they are re-determined.

A feature-oriented method requires an identification of the features. Using the same features as employed during the recognition step prevents the operation from being repeated. See, for example, the borders and the pixel grid of the screen.

Some systematic factors which can contribute to form an error larger than the intended accuracy while determining the position of the pointer with respect to the screen are the distortions introduced by the used optics, the inclination effect, the discrete detection of the image, the discrete/digital processing, and the degree of accuracy in identifying features within the detected image.

In addition to preventing this occurrence by acting on the reasons thereof, if the efficiency of the system is increased, then it is possible to introduce a feedback monitoring process in order to correct the output.

A cursor is visualized on the screen at the determined position (i.e., a known distinguishable feature is intentionally inserted). If the error is small, the visualized element is searched within the detected image in the surroundings of the point corresponding to the pointer. Once it has been identified, the correction is detected in order to obtain an accurate output.

The smaller the error, the smaller the area associated with the pointer in the surroundings of the point of the detected image in which the research is carried out.

Correction can be measured by both the previously-illustrated methods in order to determine the position with respect to a feature.

However, the correction by the second method is faster and certainly error-proof, notwithstanding the fact that the expected errors as produced by the effect-weighted measurement method are surely reduced for short distances.

If the error to be corrected is small, then the provision of locality is fulfilled and then the method can be applied in any case.

The visualization of the cursor can be detected only by the invention and not by human sight if it occurs within short periods and the cursor is small in size (for example as small as one pixel of the screen) and similar in colour to the background being overlapped therewith. When the cursor is visualized for a very short period, the cursor can be easily detected by comparison with the previous image over time, with the proviso that the elapsed time has been short enough to prevent further changes in the image. Furthermore, if the error is very small, the device is likely to conceal the used cursor from the sight of the user.

The cursor could be also considered as the extension of the pointer of the device into the virtual space or graphical environment.

If detectable features do not exist or are not deliberately used in a sufficient degree to determine a unique positional solution and a discrete array of solutions is determined, then an ambiguity-removal process has to be performed.

For example, this occurs when there are features which can be detected but not discriminated from each other, as in the case where position is determined only based on the corners of the borders of a rectangular screen (due to the selected algorithm or, for example, in the case of a mono-colour background). In this case, a unique position cannot be determined but a pair of positions, since it is not possible to discriminate a corner from its opposite corner (the internal non-conjugate corner, i.e. that formed by both different sides) without using at least one element to discriminate at least a side of the frame from its opposite side (corresponding to using a further feature at the corners to define an arrangement).

The just-described example is illustrated in FIG. 6, where it can be noted that the device 3, being located at two different positions and rotated by 180° about its own axis at one position with respect to the other position, generates the same image 30 of the considered features 31 e 32 respectively. In this diagram, only the considered features are shown, and the optical assembly is supposed to not produce distortions for sake of simplicity.

If a unique solution is not directly determined but a discrete number of permissible solutions, then the unique solution is retroactively identified by verifying the permissible solutions through the visualization and recognition of an object or cursor. This operation ca be carried out concurrently (within one refresh cycle of the screen) by visualizing different objects which are each associated with a different permissible solution. When the ambiguity is related to rotational effects of the optical assembly around its own axis, as in the scenario as shown, the concurrent verification can also be done by visualizing objects which are identical while having an identifiable fixed orientation with respect to the screen in all the permissible positions.

The feedback operation can also be carried out sequentially, with the proviso that requisite refresh cycles can comply with the total answer times which have to be conformed to the use, and then also unperceivable by human sight.

If a feedback is needed to correct the positional error, both the process can be combined in one feedback.

The already-discussed considerations apply as for making feedback objects undetectable by human sight. Furthermore, feedbacks associated with incorrect permissible solutions can be detected by the user in a reduced degree if the user is likely supposed to focus his/her sight on the position associated with the correct solution.

In the case of systematically generated ambiguities, a statistical log can be implemented to determine whether there is a solution likely to be more correct than others, in order to define a rank to be followed to establish a sequence of positions in which the cursor has to be visualized.

The shape of the casing and the arrangement of the buttons, if present, can be designed to induce the user to grasp the device only in an optimal manner. This allows to establish a most likely degree of rotation of the device about its own axis with respect to the screen (which degree is different between a left-hander and a right-hander). Accordingly, the ambiguity-removal process can be configured by first visualizing the cursor at the most likely position (that relative to the most likely rotation), and then visualizing the cursor at other positions only if this is not successful.

Cleary, since only one degree of rotation is forcibly admitted in grasping the device as condition of use for the device, the invention will operate without considering ambiguities which could be otherwise generated (if they can exist due to the already-described reasons) while only considering, in any case, the solution associated with the correct (intended) use. In this case, in order to prevent the activation of functions associated with the point as determined (indeed, such point is different from the actually selected point) due to such incorrect use, the positional output as determined can be checked by visualizing a cursor and, only after the recognition thereof, commands can be transmitted to activate the functions.

Clearly, while considering ambiguities generated by rotational effects of the device about its own axis, these ambiguities can be immediately resolved since they are not generated, and the absolute degree of rotation/orientation of the device can be measured with respect to the screen. With reference to the above example, this can be done by identifying a feature allowing an arrangement for the corners of the border to be established. Generally, this can be done by recognizing features allowing spatial “reference axes” of the screen to be uniquely determined.

Using the image of the sub-pixel grid forming the screen is highly effective since sub-pixels form triads which are uniquely oriented with respect to the screen. For example, when the above-described scenario is applied to an LCD screen consisting of sub-pixels arranged in rectangles, from left to right, according to a module “R→G→B”, a sub-pixel image—as read from left to right with respect to the references of the sensor—will be detected which is arranged according to a sequence “. . . RGBRGBR . . . ” at one position, and according to a sequence “. . . BGRBGRB . . . ” at the other position. Since the orientation of the sub-pixels with respect to the screen is known, the correct position is uniquely detected without generating potential ambiguities. The already-discussed considerations apply as for the process for absolutely measuring the rotation of the device about its own axis according to applicability scenarios.

A complication to the screen-recognition process and pointer position-determination process with respect to the screen is the likelihood that user's hand or other object can partially cover the sight of the optical assembly (for example, if the user rests his/her hand grasping the device on the screen). Accordingly, there is an increased likelihood that the features searched for cannot be detected, as well as an increased likelihood that a unique solution cannot be determined (the so-undetectable features could be unique features or features having a high discrimination power).

The first aspect can be solved by selecting, if possible, features within the whole area of the screen. However, it is to be noted that at least one corner of the rectangular border of the screen can be viewed in any case because of the specificities as established for the image detection components.

The ambiguity increase can be solved as previously described.

Furthermore, if the optical assembly is focused on the tip of the device, when the image of the screen is detected under conditions of proximity, there is an increased field of view and then an increased likelihood of identifying features up to a little time before the maximum constriction of the field of view.

As for interactions continued over time, contact interactions or even proximity interactions between the hardware device and the screen, the subsequent position can be determined either by repeating the processing to determine the first position or by detecting the movement.

The movement can be determined while complying with the provision of locality, i.e. by using a measurement based on counting the pixels of the screen in the detected image, regardless of the effects produced by the optical assembly due to proximity and inclination. Indeed, considering a short time period between two successive detections, if a cursor is visualized at the previous position and the distance thereof is measured from the new position, then the provision of locality is satisfied in any case. In fact, a sufficiently high image detection rate assures that the cursor as visualized is located in the surroundings of the new position. Under these conditions, the surroundings of the new position where the visualized element as associated with the previous position can be found is highly narrow (a bunch of pixels of the screen) and then it can be easily detected. Furthermore, since the visualized element is very close to the new position, it is confused therewith under the user (human) point of view. The already-discussed considerations apply as for making the cursor undetectable by human sight. It is also to be noted that, for drawing or italicized writing applications, there is always a feature near the new position: the last stroke to be drawn, i.e. the previously visualized stroke.

The movement can be measured by analyzing the flow of detected images based on the pixel grid of the screen, among the other things. However, this method requires a correction for the effects introduced by changes in proximity, inclination and rotation occurring along with the movements.

Clearly, when a movement is being measured, it is not required to carry out the screen-recognition process for each frame captured by the sensor. Furthermore, since the measurement of a movement includes detecting the pixel grid, such measurement inherently acts as a recognition process having at least a high discrimination power.

As already mentioned, there is no absolute assurance that a unique recognition can be made based on features in any case, and therefore there is required a process which can do it in any case.

Recognition can be made only by uniquely coupling the device to the system at a communications level. Indeed, consider the case in which the device is uniquely coupled to a system at a communications level but it operates with a pixel-grid screen of another system: it could transmit spatial information to the wrong system.

The process for uniquely recognizing a pixel-grid screen of the graphical interface system to be interacted by the user allows correct recognitions to be made with the highest confidence and a reduced consumption of computational resources under any operative scenario (existence of structurally identical screens, existence of micro-patterned sheets, limited number of detected features due to the selected algorithm, etc.) and regardless of the abilities of uniquely recognizing the screen through the use of known features under given scenarios.

The process includes a first recognition step wherein the detected image of known features having a high discrimination power is identified, such as the pixel grid, in order to exclude the most unacceptable surfaces. If the first step is successful, then the position is determined and a default cursor is visualized at the corresponding position. If the cursor is recognized by the system during the subsequent acquisition, then the recognition is unique. Indeed, positional information is transmitted to the one system to which the device is coupled at a communications level, in such a way that only such a system will produce the default cursor on the screen and the recognition will occur only if the device is actually in contact with or close to it. Only if this step is successful, the invention then enables and validates the transmission of the commands generated during and after such step.

If the interactions with the screen are continued or briefly interrupted over time, than the unique recognition process is not repeated but only that process based on elements with high discrimination powers is performed, which is in any case carried out by both the position-determination process and the movement-determination process when they include the identification of the pixel grid. A brief interruption is such an interruption which doesn't allow a user (man/woman) to change the interacting surface.

Such process can be incorporated with both a position-correction process and an ambiguity-removal process in one refresh cycle of the screen, if necessary.

Obviously, the considerations already discussed to prevent the user from perceiving the cursor apply.

Clearly, this process can be used under any scenario, or only if a unique recognition cannot be carried out through the use of the selected known features.

Notably, since this is a validation process for the first positional output based on the recognition of a properly shaped feature, it is possible to design a similar procedure making use of already existing dynamic features. In this case, the selection of dynamic features occurs following the determination of the positional output, and therefore the problem associated with the local detectability thereof can be solved. However, there are still problems of an increasingly inconvenient computational load as well as of assuring the existence of features.

The invention as disclosed until now allows the same system provided with a single screen to support more devices because, if the transmissions are different, each communications channel is associated with one device and each data point transmitted through a given channel can be associated with one given device. However, the invention allows the same device to only interact with one single-screen system at a time, regardless of whether it is a single-user system or a multi-user system. This emphasizes a major limitation in obtaining a wide system-interfacing ability and a high degree of contents portability.

For example, the same device cannot be simultaneously connected to two systems with a single screen if, for whatever reason (choice of an algorithm to simplify the processing request, structurally identical screens, etc.), the invention cannot discriminate two screens. Accordingly, when a file has to be transferred from a source system to a receipt system by the device, if the device is not first disconnected from the file-source system and then re-connected to the receipt system, the transfer cannot occur. Indeed, if the same device is connected to both the systems at a communications level, it is not possible to know which screen of which system has been subjected to the position-determination process, and therefore which system is the system to which the output has to be transmitted.

For example, in the case of only one device and only one system which is a multi-screen and multi-user system, it could not be possible to establish which screen and then which graphical environment is being interacted by the device in any case, as for the preceding case. In fact, it is possible to know that a given device and a given position are related to a given transmission, but it is not possible to know which screen is associated therewith.

The process for establishing and managing unique couplings in the presence of simultaneous connections to more systems with a pixel-grid screen allows to solve the ambiguities in recognizing the system.

During the setup step of the connections, the method includes allocating a different cursor (for example, a cursor different in colour) at least to each user made available by one or more systems on a different screen and able to be connected to the device. In this way there will be a different communications channel for each device, which allows the system to recognize the devices, and there will be a different cursor for each user on a different screen, which allows the device to recognize the screens, the users, and therefore the systems.

This allocation can occur only if known information is not sufficient to discriminate the screens of the systems which are connected at a communications level, and only for systems implementing screens which cannot be discriminated. In fact, for example, in the case of two single-screen systems, if both the systems are known to implement structurally different screens due to historical couplings whose information have been retained, than the allocation of a different cursor is not needed. In contrast with the preceding example, if a third single-screen system is introduced whose screen is historically unknown or it is known but has the same structural features as either of the other two screens, then the allocation of a different cursor would be needed only for the new system.

A system can be coupled to a device if it has not reached the maximum number of connected devices, if the system is open with respect to a device, if the relative user is open with respect to the user of the device (authentication), or if it is within the field of the wireless system.

The process is identical to the already-described unique recognition process, except that it includes transmitting the first resulting positional output to all the systems connected thereto whose relative screens have not been recognized. Such systems provide for producing the cursor corresponding thereto on the screen. The device will recognize the cursor and then the system being interacted therewith.

The screen-recognition process can be carried out only once, when each interaction with the screen begins following a “long” idle time.

The process can be used only if the screens cannot be discriminated based on known features or information.

During “long” idle times, the device provides for searching for new systems able to be connected thereto within the transmission range in addition to the previous systems and, if it is possible, for connecting to such new systems as well as for establishing unique recognition parameters, if necessary. From time to time, the system provides for checking whether established connections exist. This is all aimed to make an effective process for managing “onset” and “dead” connections.

Obviously, the provision of allocating a different cursor to each user made available on a different screen from one or more systems and able to be related to the device applies even when a different cursor is allocated to each device or communications channel (improved variety). In this case, a standard could be established which associates a specific cursor with each communications code for example, and a code-selection process could be designed based on those already established for other devices which may have been connected to the system during a setup step to connect the system to the device.

Using a cursor to be visualized as feedback to the positional output allows, regardless of the requirements in terms of recognition, output correction, ambiguity removal and movement measurement, to verify the proper functioning of the invention to the maximum extent possible, i.e. it forces the invention to operate only and exclusively according to the wills of the user as consistent with the intended uses.

Detection both of the contact pressure between pointer and screen and of the activation of buttons, if present, occurs while determining the position and movement.

When information about the size of the pixel grid of the screen in the detected image is not known a priori under contacting conditions, pressure sensor is critical in detecting the contact. The contact with the screen is recognized as such only if the screen is recognized.

The contact pressure degree (corresponding to zero if the proximity is not minimal) and the activation of buttons are associated with the positional output.

When enabled, the generation of commands through the sensor, buttons and movements of the device is managed also under non-interacting states of the concerned system with the screen.

The invention cyclically recognizes the screen and processes an output representing the position, the contact pressure as well as the activation of buttons.

The invention continuously processes the time sequence of recent outputs in order to cause the activation of commands made available by the graphical interface according to preset settings.

Parameters describing the types of uses for possible buttons, pointer/screen interactions and combinations thereof can be modified by the user through the graphical interface.

The connection of the input signals for “manipulating” the graphical interface and the types of uses for possible buttons, pointer/screen interactions and combinations thereof can be modified by the user through the graphical interface.

Internal memory allows for transferring information contained in the system implementing the graphical interface to the device by a simple device-screen interaction associated with a command. The invention determines the position, the position is associated with a graphical object, the graphical object is associated with stored contents, and the use of a command generated through a button, for example, cause the contents of the internal memory of the device to be transferred.

A reverse process allows a transfer from the device to a directory of the system (whose graphical window is associated with a position on the screen). In this process it is required either to visualize a window showing the contents as saved in the memory of the device or to visualize a temporary icon associated with the content of the memory which is selected at each occurrence as a cascade for each command pulse.

In order to transfer a content from a system to another one, an address file for the source of the content can be saved in the device, which address file allows a receipt system to withdraw such content from that of the source once the address file has been downloaded into the receipt system.

If both the source and receipt systems are communicating and sharing information about the respective activities thereof, the transfer could be also carried out by activating a “copy” function on the source system and then a “paste” function on the receipt system. This can be made only if the receipt system is aware that a “copy” command has been selected on the source system and vice versa.

Wireless communications improve the manageability of the device while allowing for a quick and user-independent coupling of the device to a system as well as to more systems simultaneously. Wireless system is designed for short-range communications. This also results in a low resource consumption.

If a memory for saving and transferring information large in size is present in the device, than the wireless system is designed with a proper bandwidth to allow for a quick transfer.

The device as provided with a digital signature process can authenticate digital documents. The signature process can apply to documents existing either in the interaction system or in the internal memory of the device. Signed documents can be either stored in the internal memory of the device or transmitted. Implementing the signature process in the device allows to reduce or even eliminate the vulnerabilities resulting from applying a signature to certain documents while the user is not aware thereof. Generally, the digital signature process requires a slot for a smart card to be inserted.

The device as provided with a user recognition or authentication process assures both the privacy of the contents stored in the internal memory, if present, while allowing the digital signature process which may be present (authentication data has to be on the smart card or exclusively associated therewith during the setup step) to be exclusively used by the owner, and the device to be used as an authentication key to access systems being interacted with. Particularly, it is very convenient to use a biometric authentication process based on the optical system of the device. For example, the process for detecting a fingerprint can only includes passing the pointer of the device over the user's finger. Biometric information associated with the user can also be used to encode/sign digital contents in manners as described in the preceding paragraph.

The device carries out internally all the processing tasks as much as possible: recognizing the screen as well as the system associated therewith, determining the absolute position, determining the movements, detecting and managing commands, storage, digital signature, user authentication, etc. in order to be independent from the system being interacted therewith.

The device as provided with a wireless internal battery recharge system is designed to minimize and facilitate the tasks for the user according to the general rationale of the invention.

Because of the highly autonomous nature of the device, it allows other potential processes to be implemented in order to further improve the man-machine interaction. For example, also considering the optical nature of the device, there can be incorporated processes for scanning, recognizing and transferring printed contents to a computer system.

The optical assembly as focused on the tip of the hardware device assures the continuous existence of a connection between the image of the screen and the optical assembly; it provides the advantage that the pointer of the device is continuously within the input field of view; it assures that the image of the pixel grid of the screen can be detected; it make easy to resolve the image of the pixel grid of the screen; it reduces the covering of the field of view due to user's hand, and it allows to detect cursors being visualized in the surroundings of the point in which the pointer of the device is (which is critical to maximize possible processes for measuring movement, correcting position and eliminating ambiguities).

1. A graphical interface pointing device comprising:
an optical assembly;
image detection means;
control and/or monitoring means;
data transceiver means;
feeding means; and
a central processing unit.

2. The device according to claim 1, further comprising a pressure sensor near said optical assembly.

3. The device according to claim 1, further comprising a data storage means.

4. The device according to claim 1, further comprising a user authentication means, wherein the user authentication means is a digital signature.

5. The device according to claim 1, wherein said optical assembly has a wide field of view, said optical assembly being located at a tip of said device.

6. The device according to claim 1, wherein resolution of said optical assembly is adapted to at least locally detect known static features, the static features being a pixel grid of a screen.

7. The device according to claim 5, wherein said optical assembly is selected from the group consisting of: fisheye-type system, a multi-image system, a catadioptric system, an internal reflection system, and a mirror-combination system.

8. The device according to claim 1, further comprising an image sensor, wherein the image sensor is a sensor selected from the group consisting of CCD sensors, CMOS sensors, and FOVEON sensors.

9. The device according to claim 8, wherein the input-output behaviour of the optical assembly and a resolution of the sensor are adapted to allow images of static and dynamic features to be detected under any intended condition of use, wherein the resolution of the sensor is selected from the group consisting of: spatial, intensity, and colour.

10. A process for determining an absolute position by using the pointing device according to claim 1, comprising:
acquiring images;
measuring a vector distance in a detected image between a position of a pointer of said pointing device and a position of at least one static or dynamic feature whose position is known with respect to a screen and produced by the screen, said vector distance being carried out by counting vertical and horizontal pixels of a sensor;
converting said vector distance based on an input-output function of an optical assembly and degrees of proximity and inclination as calculated through a same image; and
determining transitively, references for the absolute position of the pointer of the pointing device with respect to the screen.

11. The process according to claim 10, wherein borders and corners of the screen are static features, the static feature being known positions with respect to the screen.

12. The process for measuring proximity and/or inclination and/or rotation of the pointing device of claim 1, the process comprising measuring deformations or effects introduced by magnitudes into detected image of static or dynamic features of a screen with known aspect ratios.

13. The process according to claim 12, wherein a pixel grid of the screen is considered a static feature with known aspect ratios.

14. The process according to claim 10, wherein values of proximity and/or inclination and/or rotation of the device are determined by a process for measuring proximity and/or inclination and/or rotation of a pointing device, the process comprising measuring deformations or effects introduced by magnitudes into detected image of static or dynamic features of a screen with known aspect ratios, wherein the pointing device is a graphical interface pointing device comprising: an optical assembly; image detection means; control and/or monitoring means; data transceiver means; feeding means; and a central processing unit.

15. A process for uniquely recognizing a pixel-grid screen over other pixel-grid screens or surfaces by using a pointing device, wherein the process is incorporated with the process according to claim 10 if desired, the method further comprising detecting and recognizing static or dynamic features having a high discrimination power, the static or dynamic features being the pixel grid, or unique static or dynamic features as properly established and visualized if desired, wherein the pointing device is a graphical interface pointing device comprising: an optical assembly; image detection means; control and/or monitoring means; data transceiver means; feeding means; and a central processing unit.

16. A system comprising:
the pointing device according to claim 1;
a software interface adapted to couple said pointing device to one or more processors; and
one or more visualization devices coupled to said processors.

17. A process for retroactively correcting an error in a positional output by properly visualizing a given graphical element, wherein the process is associated with the process according to claim 10, wherein the pointing device is a graphical interface pointing device comprising: an optical assembly; image detection means; control and/or monitoring means; data transceiver means; feeding means; and a central processing unit.

18. A process for retroactively correcting ambiguities in a positional output by properly visualizing given graphical elements, wherein the process is associated with the process according to claim 10, wherein the pointing device graphical interface pointing device comprising: an optical assembly; image detection means; control and/or monitoring means; data transceiver means; feeding means; and a central processing unit.
